(19) United States
(12) Patent Application Publication
(10) Pub. No.: US 2018/0357757 A1
(43) Pub. Date: Dec. 13, 2018

(54) DEFECT INSPECTION APPARATUS FOR TUBULAR PRODUCT SUCH AS INTERMEDIATE TRANSFER BELT

(71) Applicant: KONICA MINOLTA, INC., Tokyo (JP)

(72) Inventor: Masahiro Kuwasako, Toyokawa-shi (JP)

(73) Assignee: KONICA MINOLTA, INC., Tokyo (JP)

(21) Appl. No.: 16/004,557

(22) Filed: Jun. 11, 2018

(30) Foreign Application Priority Data
Jun. 13, 2017 (JP) 2017-115615

(51) Int. Cl. G06T 7/00; G01N 21/88; G01N 21/954; G03G 15/00

(52) U.S. Cl. CPC G06T 7/0004; G01N 21/8851; G03G 2215/00059; G03G 15/5054; G01N 2021/9548; G01N 21/954

(57) ABSTRACT

A defect inspection apparatus comprises a light source that irradiates the outer surface of the intermediate transfer belt, a first line camera for receiving the light from the outer surface and transmitting a signal based on the received light, a light source that irradiates the inner surface of the intermediate transfer belt, and a second line camera that receives the light from the inner surface and transmits a signal based on the received light. Based on the signal received from the first line camera, the defect inspection apparatus creates an outer surface image of the outer surface. Based on the signal received from the second line camera, the defect inspection apparatus creates an inner surface image of the inner surface. Based on the outer surface image and the inner surface image, the defect inspection apparatus detects defects contained in the intermediate transfer belt.

The entire disclosure of Japanese patent application No. 2017-115615 filed on Jun. 13, 2017, is incorporated herein by reference in its entirety.

### BACKGROUND

### Technological Field

The present invention relates to a defect inspection apparatus. More specifically, the present invention relates to a defect inspection apparatus for a tubular product capable of improving defect detection accuracy.

### Description of the Related Art

Electrophotographic image forming apparatuses include MFPs (Multi Function Peripherals), facsimile machines, copying machines, printers, and so on. The MFP has a scanner function, a facsimile function, a copying function, a function as a printer, a data communication function, and a server function.

An image forming apparatus generally develops an electrostatic latent image formed on an image carrying member with a developing device to form a toner image. The image forming apparatus transfers the toner image to the sheet and then fixes the toner image on the sheet by the fixing device. Thus, the image forming apparatus forms an image on the sheet. Some image forming apparatuses form a toner image by developing an electrostatic latent image on a surface of a photoconductor with a developing device. The image forming apparatuses use a primary transfer roller to transfer the toner image to an intermediate transfer belt. The image forming apparatuses secondarily transfer the toner image on the intermediate transfer belt to a sheet by using a secondary transfer roller.

The intermediate transfer belt has a thin-walled cylindrical shape. Generally, an intermediate transfer belt is manufactured by the following method. The manufacturer prepares raw material containing thermoplastic resin, and melts the thermoplastic resin in the raw material. The manufacturer injects the raw material containing the molten thermoplastic resin into a tubular shape using a mold. The manufacturer cools the molded body obtained by injection molding while sending it out, and cuts it to a predetermined length to obtain a tubular product. The manufacturer corrects the shape of the tubular product. The manufacturer cuts the tubular product further into the length of an intermediate transfer belt. Thereafter, the manufacturer visually inspects whether there is a defect in the outer surface (outer peripheral surface) of the intermediate transfer belt in the inspection process.

For example, the following document 1 discloses a technique relating to inspection of a photoconductor drum. In the following document 1, the photoconductor drum is rotated in a counterclockwise direction at a low speed by a driving device. The first line sensor receives regular reflected light from the photoconductor drum surface by turning on a high frequency fluorescent lamp. Due to the electric signal outputted by the sensor, the image processing apparatus detects the presence or absence of color unevenness. At the same time, scattered light from the drum surface is received by the second line sensor. Depending on the electric signal outputted by the sensor, the image processing apparatus detects the presence or absence of unevenness.

### PRIOR ART (S)

### Document (s)

[Reference 1] Japanese Unexamined Patent Publication No. (Hei) 7-128240

If there is a defect due to foreign matter or local folding on the inner surface (inner peripheral surface) of the intermediate transfer belt, the size of the defect appearing on the inner surface of the intermediate transfer belt is large, and the size of the defect appearing on the outer surface of the intermediate transfer belt may be small. However, in the prior art, only the presence or absence of a defect in the outer surface of the intermediate transfer belt was inspected. For this reason, the above-described defect of the inner surface of the intermediate transfer belt was seen as a merely minute defect on the outer surface, and may be not detected in some cases. For this reason, the conventional technique has a problem that the defect detection accuracy is low. The defect of the inner surface of the intermediate transfer belt may also adversely affect the quality of the intermediate transfer belt. Therefore, in the intermediate transfer belt, the quality of the inner surface is also important as well as the outer surface.

The problem of low defect detection accuracy was not only when the inspection target was an intermediate transfer belt but also when the inspection target was a tubular product.

### SUMMARY

The present invention is directed to solve the above problems, and an object thereof is to provide a defect inspection apparatus capable of improving defect detection accuracy.

To achieve at least one of the abovementioned objects, according to an aspect of the present invention, a defect inspection apparatus according to one aspect of the present invention comprises: an external irradiation unit for irradiating an outer surface of the tubular product with light, an external light receiver for receiving the light from the outer surface and transmitting a signal based on the received light, an internal irradiation unit for irradiating an inner surface of the tubular product with light, an internal light receiver for receiving the light from the inner surface and transmitting a signal based on the received light, an image processing unit for creating an outer surface image which is a two-dimensional image of the outer surface, based on the signal received from the external light receiver, and creating an inner surface image which is a two-dimensional image of the inner surface, based on the signal received from the internal light receiver, and a detection unit for detecting a defect included in the tubular product, based on the outer surface image and the inner surface image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a front view showing a configuration of a defect inspection apparatus 100 according to a first embodiment of the present invention.

FIG. 2 is a cross-sectional view taken along line II-II in FIG. 1.

FIG. 3 is a block diagram showing a control configuration of a defect inspection apparatus 100 according to the first embodiment of the present invention.

FIG. 4 is a first diagram showing the operation of the defect inspection apparatus 100 in the first embodiment of the present invention.

FIG. 5 is a second diagram showing the operation of the defect inspection apparatus 100 according to the first embodiment of the present invention.

FIG. 6 is a third diagram showing the operation of the defect inspection apparatus 100 according to the first embodiment of the present invention.

FIG. 7 is a fourth diagram showing the operation of the defect inspection apparatus 100 according to the first embodiment of the present invention.

FIGS. 8A, 8B, and 8C are a diagram schematically showing an outer surface image and an inner surface image created by the captured image acquisition unit 103 in the first embodiment of the present invention.

FIG. 9 is a flowchart showing an image acquisition operation of a defect inspection apparatus 100 according to the first embodiment of the present invention.

FIG. 10 is a flowchart showing a defect detection operation of the defect inspection apparatus 100 according to the first embodiment of the present invention.

FIG. 11 is a flowchart showing a defect detection operation of a defect inspection apparatus 100 in the modification of the first embodiment of the present invention.

FIG. 12 is a front view showing a configuration of a defect inspection apparatus 100a according to a second embodiment of the present invention.

FIG. 13 is a front view showing a configuration of a defect inspection apparatus 100b according to a third embodiment of the present invention.

FIG. 14 is a diagram showing the operation of the defect inspection apparatus 100b in the third embodiment of the present invention.

FIG. 15 is a front view showing a configuration of a defect inspection apparatus 100c according to a fourth embodiment of the present invention.

FIG. 16 is a flowchart showing an image acquisition operation of the defect inspection apparatus 100c according to the fourth embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

In the following embodiments, the case where the inspection target of the defect inspection apparatus is an intermediate transfer belt will be described. The inspection target of the defect inspection apparatus of the present invention may be any tubular product. Other than the intermediate transfer belt, the inspection target may be a photoconductor, a fixing belt, a tubular product before cutting into a product length of an intermediate transfer belt (intermediate transfer belt material) or the like.

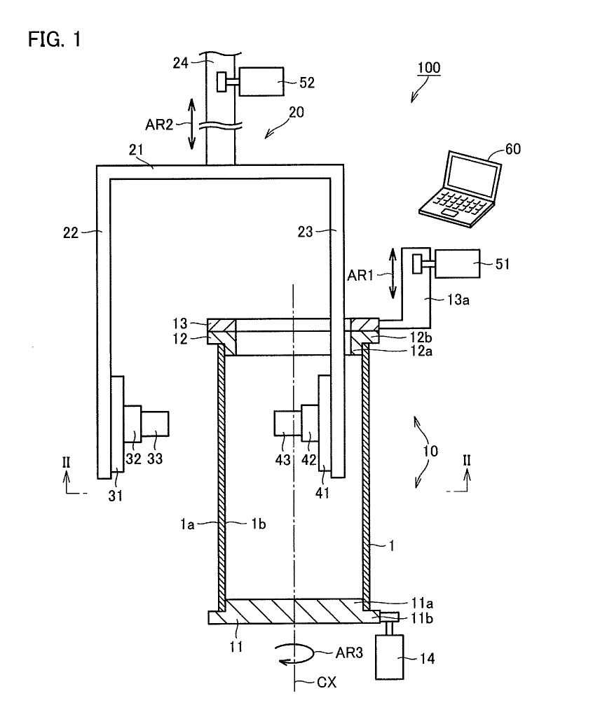

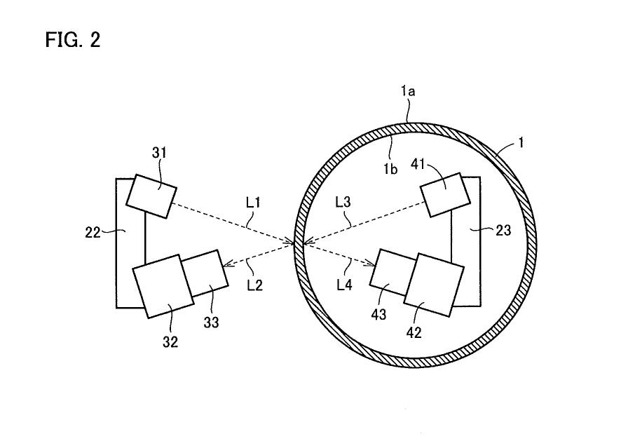

FIG. 1 is a front view showing a configuration of a defect inspection apparatus 100 according to a first embodiment of the present invention. FIG. 2 is a cross-sectional view taken along the line II-II in FIG. 1. In FIG. 2, the configurations of the arms 22 and 23, the light sources 31 and 41, the line cameras 32 and 42, and the lenses 33 and 43 which are visible from the cross section are shown.

With reference to FIG. 1 and FIG. 2, the defect inspection apparatus 100 in the present embodiment inspects the intermediate transfer belt 1 (an example of a tubular product). The intermediate transfer belt 1 is a thin-walled cylindrical shape. The intermediate transfer belt 1 includes a central axis CX, an outer surface (outer peripheral surface) 1a, and an inner surface (inner peripheral surface) 1b. The defect inspection apparatus 100 includes rotating part 10, frame 20, light sources 31 (an example of an external irradiation unit) and 41 (an example of an internal irradiation unit), line cameras 32 (an example of an external light receiver) and 42 (an example of an internal light receiver), lenses 33 and 43, a bearing drive unit 51, a camera light source movement drive unit 52 (an example of a movement drive unit), and a PC (Personal Computer) 60.

The rotating part 10 rotates the intermediate transfer belt 1 around the central axis CX. The rotating part 10 includes a rotary table 11 (an example of a first holding unit), a bearing 12 (an example of a second holding unit), a rotating rail 13, and a rotary drive unit 14.

In the state where the central axis CX is in the vertical direction (longitudinal direction in FIG. 1), the rotary table 11 holds the lower end portion of the intermediate transfer belt 1. The rotary table 11 is annular and includes a small diameter part 11a and a large diameter part 11b. The small diameter part 11a is provided on the large diameter part 11b. By engagement of the outer peripheral surface of the small diameter part 11a with the inner peripheral surface of the lower end portion of the intermediate transfer belt 1, the rotary table 11 holds the intermediate transfer belt 1.

With the central axis CX being in the vertical direction, the bearing 12 holds the upper end portion of the intermediate transfer belt 1. The bearing 12 is annular and includes a small diameter part 12a and a large diameter part 12b. The small diameter part 12a is provided below the large diameter part 12b. By engagement of the outer peripheral surface of the small diameter part 12a with the inner peripheral surface of the upper end portion of the intermediate transfer belt 1, the bearing 12 holds the intermediate transfer belt 1. The bearing 12 plays a role of preventing vibration (shaking) generated when the intermediate transfer belt 1 is rotated.

The rotating rail 13 includes an annular rail. The rotating rail 13 is engaged with the bearing 12 by the annular rail, and rotatably supports the bearing 12. The rotating rail 13 includes an extending part 13a which receives power from the bearing drive unit 51.

The rotary drive unit 14 powers the rotary table 11 and the intermediate transfer belt 1 through the outer peripheral surface of the large diameter part 11b of the rotary table 11. As a result, the rotary drive unit 14 rotates the rotary table 11 and the intermediate transfer belt 1 around the central axis CX, as indicated by the arrow AR3. At this time, the bearing 12 is also rotated (rotates) along the annular rail of the rotating rail 13, by the power received from the rotary drive unit 14 via the rotary table 11 and the intermediate transfer belt 1. When rotating the intermediate transfer belt 1, there is no friction between the bearing 12 and the intermediate transfer belt 1.

The frame 20 includes a main body part 21, arms 22 and 23 (examples of the first and the second frames), and extending part 24. The main body part 21 is in the shape of a bar and extends in the horizontal direction. Each of the arms 22 and 23 protrudes downward from the main body part 21. The extending part 24 is a part receiving power from the camera light source movement drive unit 52.

The light source 31, the line camera 32, and the lens 33 are fixed to the arm 22. The light source 31 irradiates the light L1 to the outer surface 1a of the intermediate transfer belt 1. The line camera 32 receives the reflected light L2 from the outer surface 1a via the lens 33, and transmits a signal based on the received reflected light L2 to the PC 60.

The light source 41, the line camera 42, and the lens 43 are fixed to the arm 23. The light source 41 irradiates the inner surface 1b of the intermediate transfer belt 1 with light L3. The line camera 42 receives the reflected light L4 from the inner surface 1b via the lens 43 and transmits a signal based on the received reflected light L4 to the PC 60.

It is preferable that the light source 31 and the light source 41 are opposed to each other, the line camera 32 and the line camera 42 are opposite to each other, and the lens 33 and the lens 43 are opposed to each other. Thus, the outer surface 1a and the inner surface 1b at the same position on the intermediate transfer belt 1 can be photographed simultaneously using the line camera 32 and the line camera 42.

The bearing drive unit 51 powers bearing 12 and the rotating rail 13 through the extending part 13a. Thereby, as indicated by an arrow AR1, the bearing drive unit 51 moves the bearing 12 and the rotating rail 13 along the central axis CX (in the vertical direction). The bearing drive unit 51 inserts and removes each of the arm 23, the light source 41, the line camera 42, and the lens 43 to and from the inside of the intermediate transfer belt 1, through the inner hole of the bearing 12 and the rotating rail 13. By making the bearing 12 and the rotating rail 13 moveable, attachment and detachment of the intermediate transfer belt 1 to and from the rotary table 11 and the bearing 12 becomes easy. In case that the rotary table 11 is annular, the bearing drive unit 51 may move the light source 41, the line camera 42, and the lens 43 into and out of the interior of the intermediate transfer belt 1, through the hole inside the rotary table 11.

The camera light source movement drive unit 52 gives power through the extending part 24. Thereby, as indicated by the arrow AR2, the camera light source movement drive unit 52 moves the frame 20, the light sources 31 and 41, the line cameras 32 and 42, and the lenses 33 and 43 along the central axis CX (vertically).

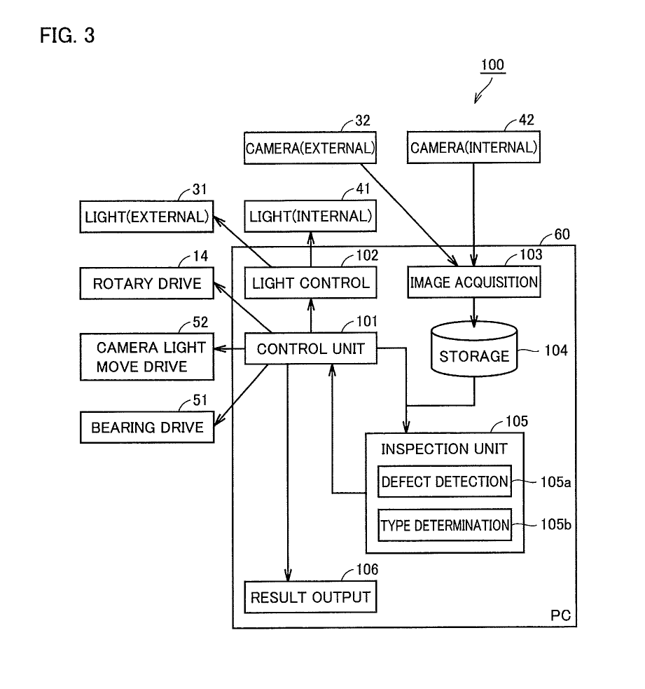

The PC 60 controls the operation of the entire defect inspection apparatus 100. The PC 60 is configured by hardware such as a CPU (Central Processing Unit), a ROM (Read Only Memory), a RAM (Random Access Memory), an operation unit, a display unit, and a storage unit 104 (FIG. 3). The PC 60 is connected to a rotary drive unit 14, light sources 31 and 41, line cameras 32 and 42, a bearing drive unit 51, and a camera light source movement drive unit 52.

FIG. 3 is a block diagram showing a control configuration of the defect inspection apparatus 100 according to the first embodiment of the present invention.

Referring to FIG. 3, the defect inspection apparatus 100 has a control unit 101, a light source control unit 102, a captured image acquisition unit 103 (an example of an image processing unit), a storage unit 104, an inspection unit 105 (an example of an inspection unit), and a result output unit 106. Each of the control unit 101, light source control unit 102, captured image acquisition unit 103, inspection unit 105, and result output unit 106 is a function realized by the PC 60.

The control unit 101 controls the entire PC 60. The control unit 101 also controls the operation of each of the rotary drive unit 14, the bearing drive unit 51 and the camera light source movement drive unit 52.

The light source control unit 102 controls each of the light sources 31 and 41.

The captured image acquisition unit 103 receives signals based on the reflected light L2 from the line camera 32, and creates an outer surface image which is a two-dimensional image of the outer surface 1a, based on the received signals. The captured image acquisition unit 103 receives signals based on the reflected light L4 from the line camera 42, and creates an inner surface image which is a two-dimensional image of the inner surface 1b, based on the received signals. The captured image acquisition unit 103 stores the created outer surface image and the inner surface image in the storage unit 104.

The storage unit 104 is made up of an HDD (Hard Disk Drive) or the like, and stores various kinds of information.

The inspection unit 105 includes a defect detection process unit 105a (an example of an outer surface detection unit and an inner surface detection unit) and a defect type determination unit 105b (an example of a determination unit and an identification unit). The defect detection process unit 105a detects defects included in the intermediate transfer belt 1, based on the outer surface image and the inner surface image. When a defect is defected by the defect detection process unit 105a, the defect type determination unit 105b determines the type of the defect.

The result output unit 106 displays the inspection result by the inspection unit 105 on the display unit of the PC 60 or the like.

Subsequently, the operation of the defect inspection apparatus 100 in the present embodiment will be described.

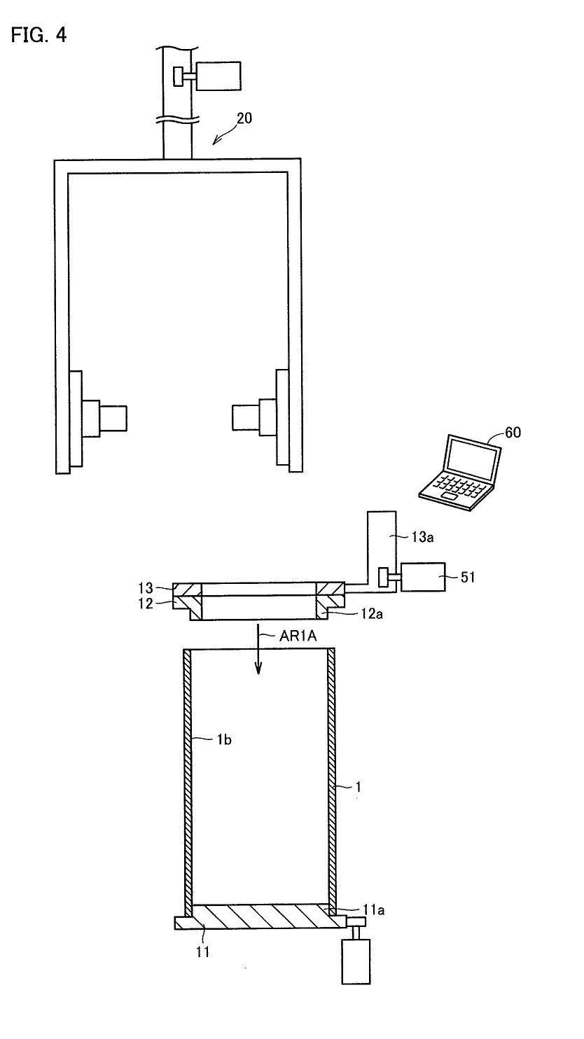

FIGS. 4 to 7 are diagrams showing the operation of the defect inspection apparatus 100 according to the first embodiment of the present invention.

Referring to FIG. 4, the bearing drive unit 51 raises the bearing 12 and the rotating rail 13. At the top of the rotary table 11, the bearing drive unit 51 makes the bearing 12 and the rotating rail 13 well separated from the rotary table 11. Also, the camera light source movement drive unit 52 raises the frame 20. At the top of the bearing 12 and the rotating rail 13, the camera light source movement drive unit 52 makes the frame 20 well separated from the bearing 12 and the rotating rail 13.

Next, the operator inserts the lower end portion of the intermediate transfer belt 1 into the small diameter part 11a of the rotary table 11. The outer peripheral surface of the small diameter part 11a of the rotary table 11 contacts the inner surface 1b of the intermediate transfer belt 1.

Subsequently, as indicated by an arrow AR 1 A, the bearing drive unit 51 lowers the bearing 12 and the rotating rail 13. The bearing drive unit 51 inserts the small diameter part 12a of the bearing 12 into the upper end portion of the intermediate transfer belt 1. The outer peripheral surface of the small diameter part 12a of the bearing 12 is in contact with the inner surface 1b of the intermediate transfer belt 1. As a result, the intermediate transfer belt 1 is fixed to the rotating part 10.

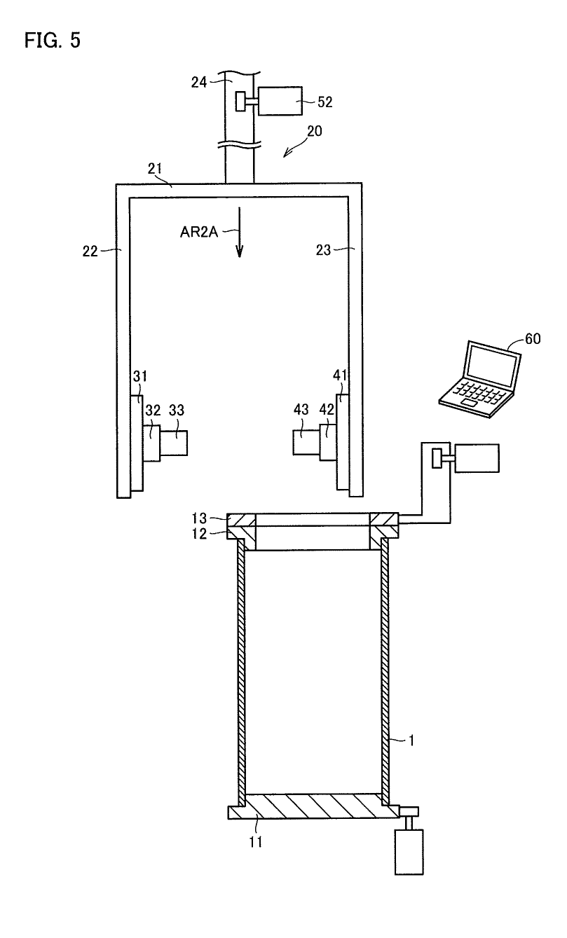

Referring to FIG. 5, the camera light source movement drive unit 52 then lowers the frame 20 as indicated by the arrow AR2A. The camera light source movement drive unit 52 moves each of the light sources 31 and 41, the line cameras 32 and 42, and the lenses 33 and 43 to the first position. Through the inner holes of the bearing 12 and the rotating rail 13, arm 23, light source 41, line camera 42, and lens 43 are inserted inside the intermediate transfer belt 1. At this time, it is preferable that the intermediate transfer belt 1 be fixed at a position where the distance from the line camera 32 to the outer surface 1a of the intermediate transfer belt 1 is the same as the distance from the line camera 42 to the inner surface 1b of the intermediate transfer belt 1.

Here, the first position is where the line camera 32 photographs the area of the outer surface 1a at the upper part of the intermediate transfer belt 1 and the line camera 42 photographs the area of the inner surface 1b at the upper part of the intermediate transfer belt 1.

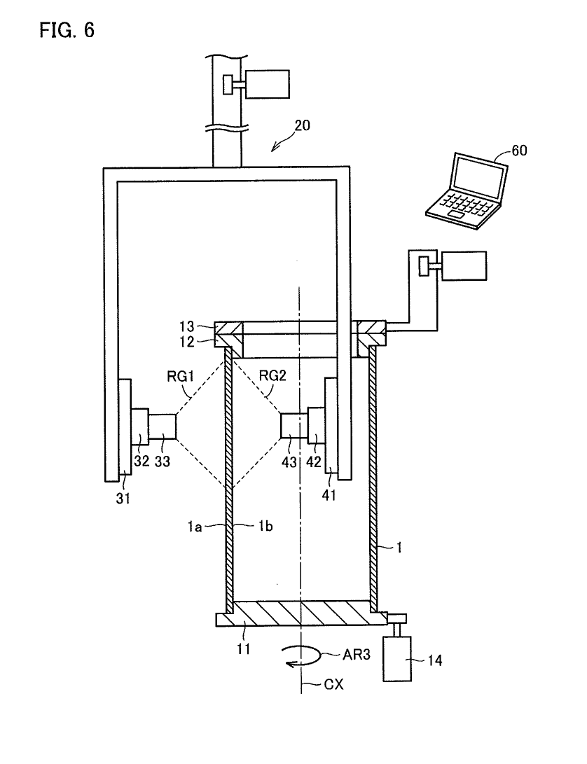

Referring to FIG. 6, as indicated by the arrow AR3, each of the line cameras 32 and 42 photographs each of the areas RG1 and RG2 while causing the intermediate transfer belt 1 to make one revolution by the rotary drive unit 14. The light source 31 illuminates the area of the outer surface 1a passing through the area RG1. The line camera 32 receives the reflected light and transmits a signal based on the received reflected light to the captured image acquisition unit 103. Light source 41 illuminates the area of inner surface 1b passing through area RG2.

The line camera 42 receives the reflected light and transmits a signal based on the received reflected light to the captured image acquisition unit 103. Based on the signal received from the line camera 32, the captured image acquisition unit 103 creates an outer surface image of the outer surface 1a on the upper part of the intermediate transfer belt 1. Based on the signal received from the line camera 42, the captured image acquisition unit 103 creates an inner surface image of the inner surface 1b of the upper part of the intermediate transfer belt 1.

During rotation of the intermediate transfer belt, at the same timing as the timing at which the line camera 32 receives light from a predetermined area on the outer surface 1a, the line camera 42 preferably receives light from an area corresponding to the predetermined area on the inner surface 1b,

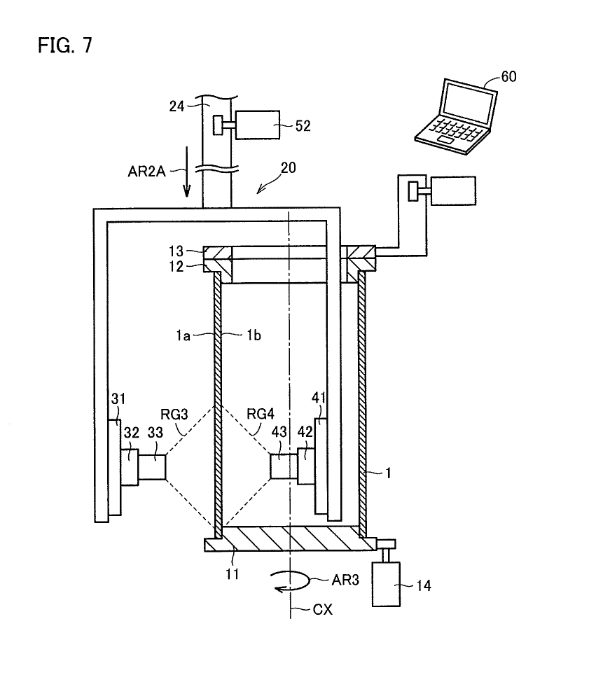

With reference to FIG. 7, as indicated by the arrow AR2A, the camera light source movement drive unit 52 then lowers the frame 20 and moves each of the light sources 31 and 41, the line cameras 32 and 42, and the lenses 33 and 43 to the second position.

Here, the second position is where the line camera 32 photographs the area of the outer surface 1a at the lower part of the intermediate transfer belt 1 and the line camera 42 photographs the area of the inner surface 1b at the lower part of the intermediate transfer belt 1.

Subsequently, as indicated by the arrow AR3, while the intermediate transfer belt 1 is rotated one turn by the rotary drive unit 14, each of the line cameras 32 and 42 photographs each of the areas RG3 and RG4. Light source 31 illuminates the area of outer surface 1a passing through area RG3. The line camera 32 receives the reflected light and transmits a signal based on the received reflected light to the captured image acquisition unit 103. Light source 41 illuminates the area of inner surface 1b passing through area RG4. The line camera 42 receives the reflected light and transmits a signal based on the received reflected light to the captured image acquisition unit 103. Based on the signal received from the line camera 32, the captured image acquisition unit 103 creates an outer surface image of the outer surface 1a of the lower part of the intermediate transfer belt 1. Based on the signal received from the line camera 42, the captured image acquisition unit 103 creates an inner surface image of the inner surface 1b of the lower part of the intermediate transfer belt 1.

In the above description, the case where the areas serving as the inspection targets of the outer surface 1a and the inner surface 1b of the intermediate transfer belt 1 are photographed in two times was described. The number of times of photographing is set to an arbitrary number of times, based on the relationship between the length of the area that is the inspection target of the intermediate transfer belt 1 in the central axis CX direction and the size of the area that can be photographed by each of the line cameras 32 and 42.

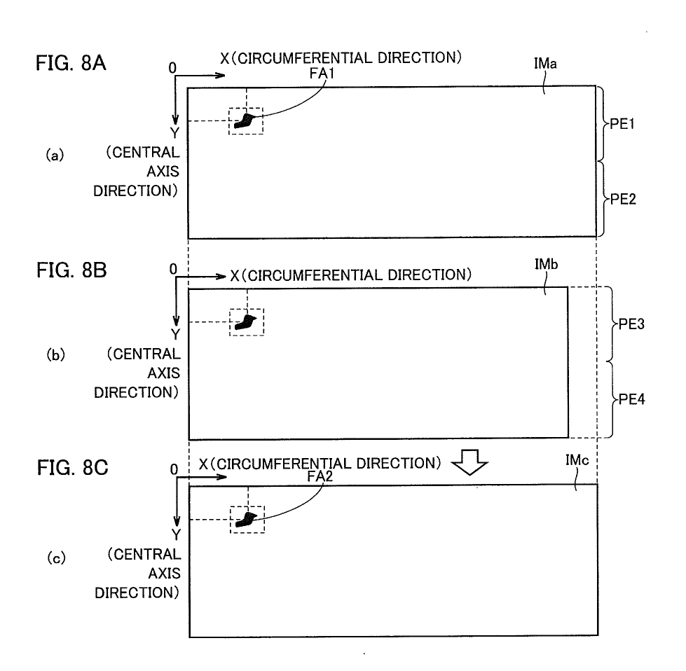

FIG. 8 is a diagram schematically showing the outer surface image and the inner surface image created by the captured image acquisition unit 103 in the first embodiment of the present invention. FIG. 8A shows the outer surface image, FIG. 8B shows the inner surface image before correction, and FIG. 8C shows the inner surface image. In FIG. 8, the circumferential direction of the intermediate transfer belt 1 is the x-axis direction, and the central axis CX direction is the y-axis direction.

Referring to FIG. 8A, the captured image acquisition unit 103 synthesizes the outer surface image PE1 at the upper part of the intermediate transfer belt 1 (the image taken by the line camera 32 for the first time), and the outer surface image PE2 at the lower part of the intermediate transfer belt 1 (the image taken by the line camera 32 for the second time) in the central axis CX direction. Thereby, the outer surface image IMa which is an image of the entire area to be the inspection target of the outer surface 1a of the intermediate transfer belt 1 is created.

With reference to FIG. 8B, the captured image acquisition unit 103 synthesizes the image of the cylindrical area of the inner surface 1b at the upper part of the intermediate transfer belt 1 (the image taken by the line camera 42 for the first time) PE3, and the image of the cylindrical area of the inner surface 1b at the lower part of the intermediate transfer belt 1 (the image taken by the line camera 42 for the second time) PE 4 in the central axis CX direction. As a result, the inner surface image IMb which is an image of the entire area to be the inspection target of the inner surface 1 b of the intermediate transfer belt 1 is created.

Referring to FIG. 8C, if the thickness of the intermediate transfer belt 1 is not negligible, the outer surface image IMa is longer than the inner surface image IMb in the circumferential direction. Therefore, in order to make the circumferential length of the inner surface image IMb equal to the circumferential length of the outer surface image IMa, the captured image acquisition unit 103 may create a modified inner surface image IMc, by enlarging the inner surface image IMb. As a result, the coordinates (x, y) of the outer surface image IMa coincide with the coordinates (x, y) of the inner surface image IMc.

Based on the outer surface image IMa, the defect detection process unit 105a detects defects included in the outer surface 1a. Also, based on the inner surface image IMc (or IMb), the defect detection process unit 105a detects defects included in the inner surface 1b. When a defect FA1 is detected on one of the outer surface 1a and the inner surface 1b (the outer surface 1a in this case) by the defect detection process unit 105a, the defect type determination unit 105b determines whether defect FA2 is detected at a position corresponding to the position of the defect FA1, on the other surface (the inner surface 1b in this case) of the outer surface 1a and the inner surface 1b. In general, defects have different lightness and the like compared with portions other than the defects.

When it is determined that the defect FA2 is detected at the position corresponding to the defect FA1 on the other surface, the defect type determination unit 105b identifies the defect FA1 detected on one surface and the defect FA2 detected on the other surface as the same defect of “folding defect” (an example of a first defect).

The folding defect is a defect of the unevenness caused by the intermediate transfer belt 1 being locally folded. The folding defect is often detected in both the outer surface 1a and the inner surface 1b. The negative impact of folding defect on the quality of intermediate transfer belt 1 is great.

When it is determined that the defect FA2 is not detected at the position corresponding to the defect FA1 on the other surface, the defect type determination unit 105b does not identify defect FA1 as a folding defect.

More specifically, when defect FA2 is detected on inner surface 1b, the defect type determination unit 105b determines whether a defect is detected at the position on the outer surface 1a corresponding to the position of the defect FA2. When it is determined that no defect is detected at the position on the outer surface 1a corresponding to the position of the defect FA2, the defect type determination unit 105b may not identify the defect FA2 detected by the inner surface 1b as a defect.

The reason is that for the intermediate transfer belt 1, the surface condition of the outer surface 1a is important. Other defects (examples of second defects, such as “dirt” and “scratch”) other than the folding defect on the inner surface 1b have a small adverse effect on the quality of the intermediate transfer belt 1. Even if such the defects exist, it can be regarded as a nondefective product in actual manufacture.

Further, when the defect FA1 is detected on the outer surface 1a, the defect type determination unit 105b determines whether or not a defect is detected at the position on the inner surface 1b corresponding to the position of the defect FA1. When it is determined that no defect is detected at the position on the inner surface 1b corresponding to the position of the defect FA1, the defect type determination unit 105b may identify defect FA1 as another defect other than folding defect. Based on the size threshold, the defect type determination unit 105b may also determine whether to identify defect FA1 as another defect.

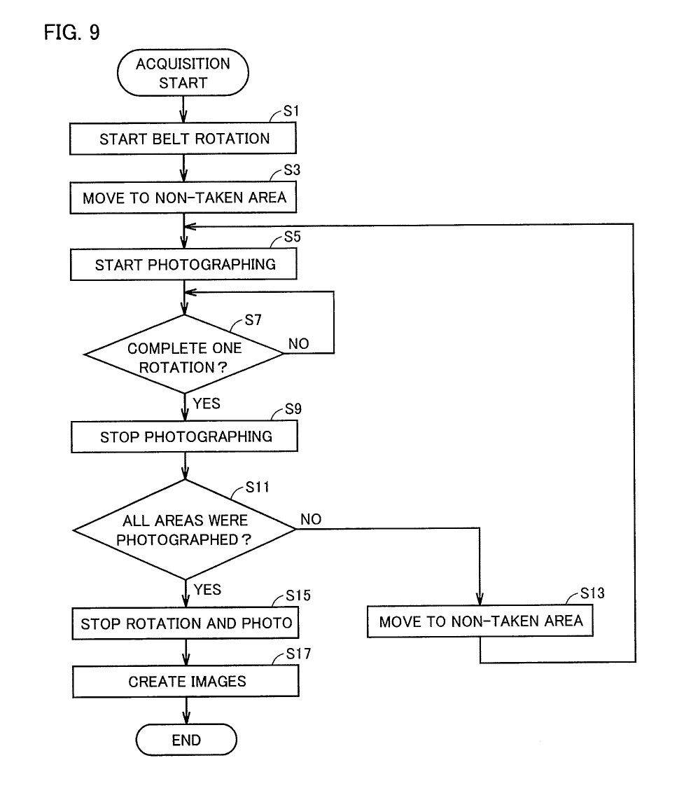

FIG. 9 is a flowchart showing the image acquisition operation of the defect inspection apparatus 100 according to the first embodiment of the present invention. Note that the subsequent flowcharts are executed by CPU of the PC 60 loads the program stored in the ROM into the RAM.

Referring to FIG. 9, the CPU starts to rotate the intermediate transfer belt 1 (S1), and moves the line cameras 32 and 42 to the shooting position of the not-taken area (S3). The CPU starts photographing (S5), and determines whether the intermediate transfer belt 1 makes one complete rotation from the start of photographing (S7). The CPU repeats the process of step S7 until it is determined that the intermediate transfer belt 1 makes one complete rotation from the start of photographing.

In step S7, when it is determined that the intermediate transfer belt 1 makes one rotation from the start of photographing (YES in S7), the CPU stops photographing the intermediate transfer belt 1 (S9), and determines whether photography of all areas of the intermediate transfer belt 1 is completed (S11).

In step S11, when it is determined that photography of all areas of the intermediate transfer belt 1 is not completed (NO in S 11), the CPU moves the line cameras 32 and 42 to the shooting position of the not-taken area (S13), and the process proceeds to step S5.

In step S11, when it is determined that photography of all areas of the intermediate transfer belt 1 has been completed (YES in S11), the CPU stops rotation and photographing of the intermediate transfer belt 1 (S15), creates an outer surface image and an inner surface image (S17), and terminates the process.

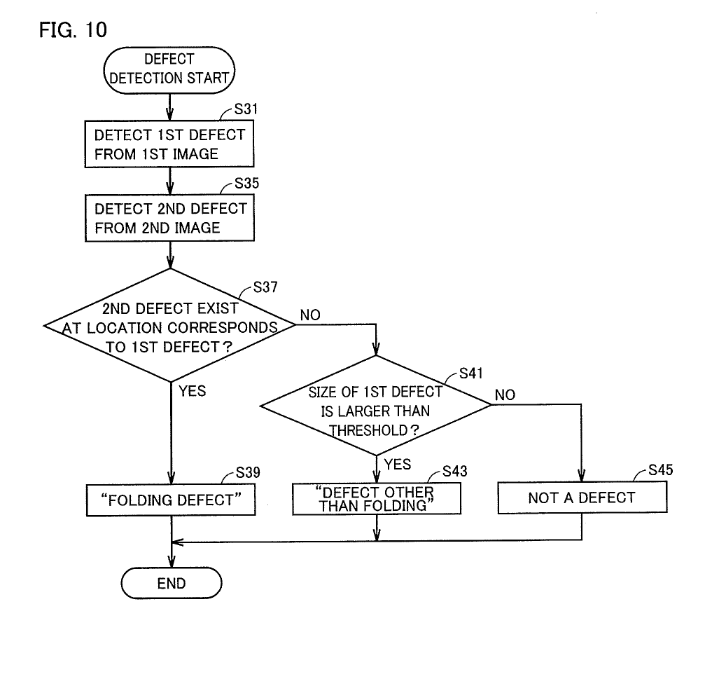

FIG. 10 is a flowchart showing the defect detection operation of the defect inspection apparatus 100 according to the first embodiment of the present invention.

Referring to FIG. 10, the CPU detects a first defect from the first read image which is one of the outer surface 1a and the inner surface 1b (S31). The CPU detects a second defect from the second read image which is the other one of the outer surface 1a and the inner surface 1b (S35). Subsequently, the CPU determines whether or not a second defect exists at a position corresponding to the position of the first defect (S37).

In step S37, when it is determined that a second defect is present at a position corresponding to the position of the first defect (YES in S37), the CPU determines that the first and second defects are folding defects (S39), and ends the process.

In step S37, when it is determined that the second defect does not exist at the position corresponding to the position of the first defect (NO in S37), the CPU determines whether or not the magnitude of the first defect is greater than or equal to the determination threshold value (S41).

In step S41, when it is determined that the magnitude of the first defect is equal to or greater than the determination threshold (YES in S41), the CPU determines that the first defect is another defect other than the folding defect (S43), and ends the process.

In step S41, when it is determined that the magnitude of the first defect is not equal to or greater than the determination threshold value (NO in S41), the CPU determines that the first defect is not a defect (S45), and ends the process.

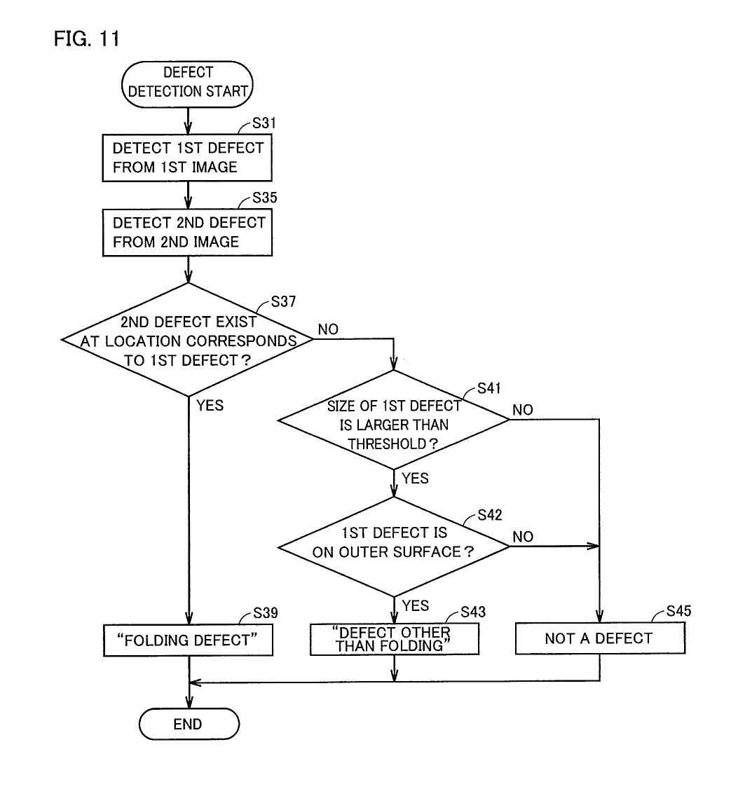

FIG. 11 is a flowchart showing the defect detection operation of the defect inspection apparatus 100 in the modification of the first embodiment of the present invention.

Referring to FIG. 11, this flowchart is different from the flowchart of FIG. 10 in that the process of step S42 is performed in the case where the process proceeds to YES in step S41 of FIG. 10.

In step S42, the CPU determines whether or not the first defect is a defect of the outer surface (S42).

In step S42, when it is determined that the first defect is a defect of the outer surface (YES in S42), the CPU determines that the first defect is another defect other than the folding defect (S43), and ends the process.

In step S42, when it is determined that the first defect is not a defect of the outer surface (NO in S42), the CPU determines that the first defect is not a defect (S43), and terminates the process.

Processing other than those described above in this flowchart is similar to the flowchart of FIG. 10, so description thereof will not be repeated.

According to the present embodiment, the presence or absence of defects in the outer surface and the inner surface of the intermediate transfer belt is inspected. Therefore, defect detection accuracy can be improved.

### Second Embodiment

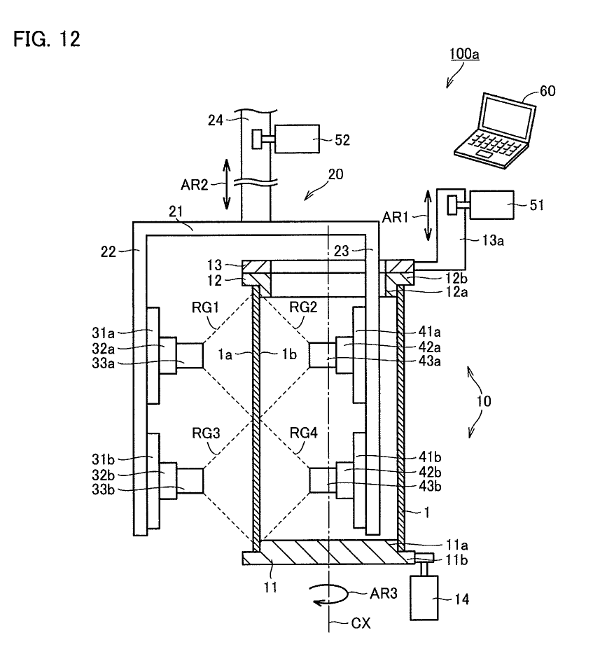

FIG. 12 is a front view showing the structure of a defect inspection apparatus 100a according to the second embodiment of the present invention.

Referring to FIG. 12, as a configuration for photographing the outer surface 1a, the defect inspection apparatus 100a in the present embodiment includes a plurality of light sources 31a and 31b, a plurality of line cameras 32a and 32b, and a plurality of lenses 33a and 33b.

The light sources 31a and 31b are arranged along the central axis CX (in the vertical direction) and are fixed to the arm 22. The line cameras 32a and 32b are arranged along the central axis CX (in the vertical direction) and fixed to the arm 22. The lenses 33a and 33b are arranged along the central axis CX (in the vertical direction) and are fixed to the arm 22.

The light source 31a irradiates the area RG1 on the upper part of the outer surface 1a of the rotating intermediate transfer belt 1. The line camera 32a receives reflected light from the area RG1 of the outer surface 1a via the lens 33a and transmits a signal based on the received reflected light to the PC 60. The light source 31b illuminates the area RG3 in the lower part of the outer surface 1 a of the rotating intermediate transfer belt 1. The line camera 32b receives the reflected light from the area RG3 of the outer surface 1a via the lens 33b and transmits a signal based on the received reflected light to the PC 60. The areas RG1 and RG3 are different areas, but they may partially overlap.

Further, as a configuration for photographing the inner surface 1b, the defect inspection apparatus 100a includes a plurality of light sources 41a and 41b, a plurality of line cameras 42a and 42b, and a plurality of lenses 43a and 43b.

Along the central axis CX (vertically), the light sources 41a and 41b are arranged and fixed to the arm 23. The line cameras 42a and 42b are arranged along the central axis CX (in the vertical direction) and are fixed to the arm 23. Along the central axis CX (vertically), the lenses 43a and 43b are arranged and fixed to the arm 23.

The light source 41a irradiates the area RG2 at the top of the inner surface 1b of the intermediate transfer belt 1 with light. The line camera 42a receives the reflected light from the area RG2 of the inner surface 1b via the lens 43a and transmits a signal based on the received reflected light to the PC 60. The light source 41b irradiates the area RG 4 at the bottom of the inner surface 1b of the intermediate transfer belt 1 with light. The line camera 42b receives reflected light from the area RG4 of the inner surface 1b via the lens 43b and transmits a signal based on the received reflected light to the PC 60. The areas RG 2 and RG 4 are different areas, but they may partially overlap.

The configuration and operation of the defect inspection apparatus 100a in the present embodiment is the same as the configuration and operation of the defect inspection apparatus 100 in the first embodiment. For this reason, the same members are denoted by the same reference numerals, and description thereof will not be repeated.

According to the present embodiment, it is possible to photograph all necessary areas of the outer surface 1a and the inner surface 1b of the intermediate transfer belt 1, while the intermediate transfer belt 1 makes one rotation. It is possible to reduce the number of times of rotating the intermediate transfer belt 1 and the number of times of moving the line camera, and it is possible to shorten the time required for the inspection.

### Third Embodiment

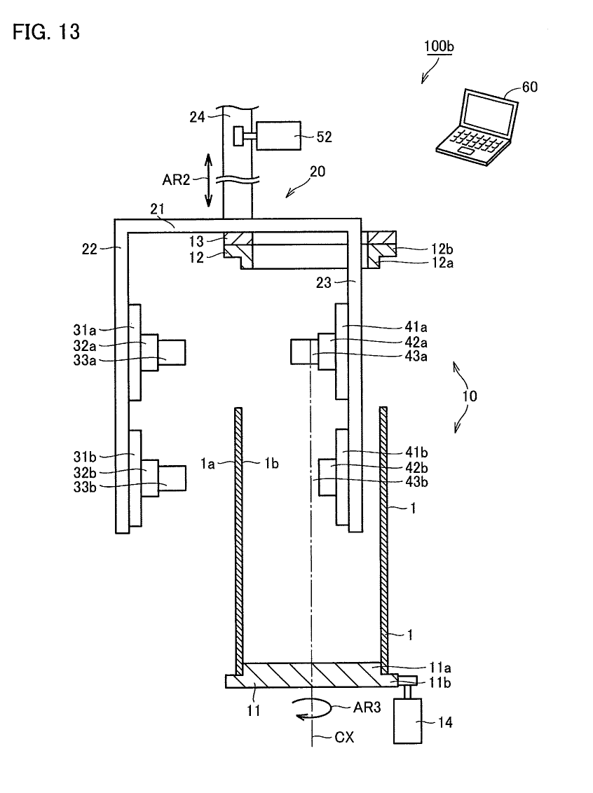

FIG. 13 is a front view showing the structure of a defect inspection apparatus 100b according to the third embodiment of the present invention.

Referring to FIG. 13, in the defect inspection apparatus 100b in the present embodiment, the bearing 12 and the rotating rail 13 are fixed to the frame 20. The upper surface of the rotating rail 13 is in contact with the lower surface of the main body part 21 of the frame 20. With this, the camera light source movement drive unit 52 is able to move the bearing 12 and the rotating rail 13 along the central axis CX, together with frame 20, light sources 31a, 31b, 41a, and 41b, line cameras 32a, 32b, 42a, and 42b and lenses 33a, 33b, 43a, and 43b.

Next, the operation of the defect inspection apparatus 100b in the present embodiment will be described.

The camera light source movement drive unit 52 raises the bearing 12 and the rotating rail 13 together with the frame 20 and so on. Above the top of the rotary table 11, the camera light source movement drive unit 52 places the bearing 12 and the rotating rail 13 sufficiently away from the rotary table 11. Next, the operator inserts the lower end portion of the intermediate transfer belt 1 into the small diameter part 11a of the rotary table 11.

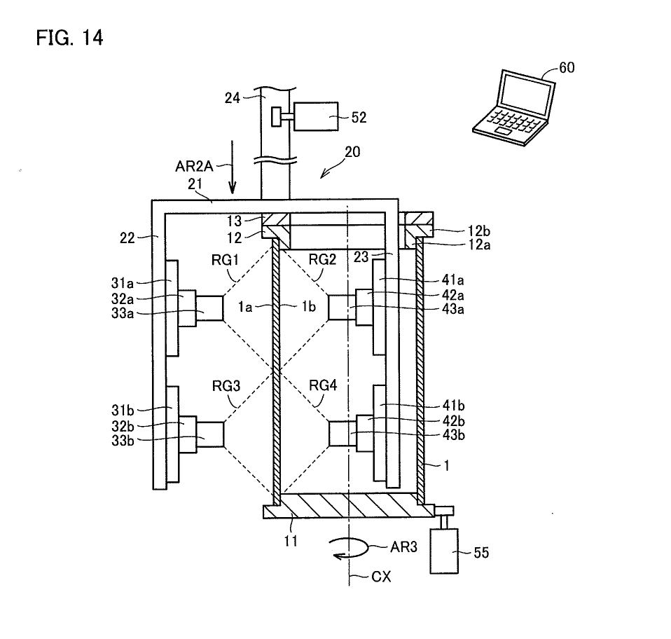

FIG. 14 is a diagram showing the operation of the defect inspection apparatus 100b in the third embodiment of the present invention.

Referring to FIG. 14, the camera light source movement drive unit 52 then lowers the frame 20 as indicated by the arrow AR2A. The camera light source movement drive unit 52 moves the light sources 31a and 41a, the line cameras 32a and 42a, and the lenses 33a and 43a to the first position. The camera light source movement drive unit 52 moves each of the light sources 31b and 41b, the line cameras 32b and 42b, and the lenses 33b and 43b to the second position.

Here, the first position is where the line camera 32a takes an image of the area of the outer surface 1a on the upper part of the intermediate transfer belt 1 and the line camera 42a photographs the area of the inner surface 1b on the upper part of the intermediate transfer belt 1. The second position is where the line camera 32b takes an image of the area of the outer surface 1a on the lower part of the intermediate transfer belt 1 and the line camera 42b photographs the area of the inner surface 1b on the lower part of the intermediate transfer belt 1.

The light sources 31a and 41a, the line cameras 32a and 42a, and the lenses 33a and 43a are moved to the first position. The light sources 31b and 41b, the line cameras 32b and 42b, and the lenses 33b and 43b are moved to the second position. In this state, the bearing 12 and the rotating rail 13 descend until the small diameter part 12a of the bearing 12 is inserted into the upper end portion of the intermediate transfer belt 1. As a result, the intermediate transfer belt 1 is fixed to the rotating part 10.

Subsequently, as indicated by an arrow AR3, while rotating intermediate transfer belt 1 one turn with rotary drive unit 14, each of the line cameras 32a, 32b, 42a, and 42b images each of the areas RG1, RG3, RG2, and RG4. As a result, the image of the cylindrical area of the outer surface 1a on the upper part of the intermediate transfer belt 1 is photographed by the line camera 32a. An image of the cylindrical area of the inner surface 1b on the upper part of the intermediate transfer belt 1 is photographed by the line camera 42a. An image of the cylindrical area of the outer surface 1a at the lower part of the intermediate transfer belt 1 is photographed by the line camera 32b. An image of the cylindrical area of the inner surface 1b at the lower part of the intermediate transfer belt 1 is photographed by the line camera 42b.

The configuration and operation of the defect inspection apparatus 100b in the present embodiment other than those described above are similar to those of the defect inspection apparatus 100a in the second embodiment. For this reason, the same members are denoted by the same reference numerals, and description thereof will not be repeated.

According to the present embodiment, it is possible to integrally (synchronously) move bearing 12 and rotating rail 13, and frame 20, light sources 31a, 31b, 41a, and 41b, line cameras 32a, 32b, 42a, and 42b, and lenses 33a, 33b, 43a, and 43b. This makes it possible to reduce the actuators (such as the extending part 13a and the bearing drive unit 51 in FIG. 1) for moving the parts in the defect inspection apparatus.

### Fourth Embodiment

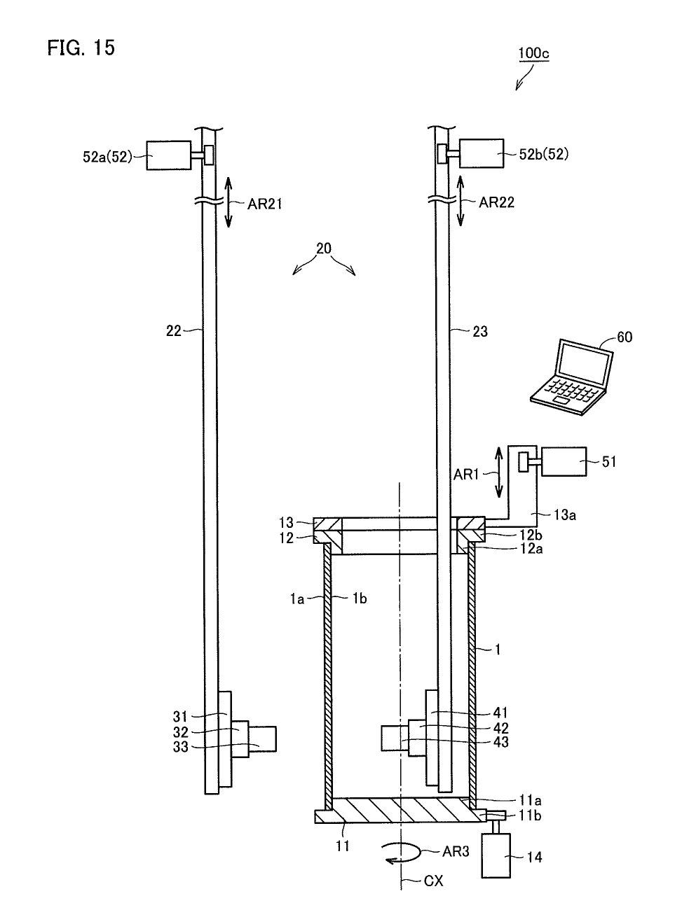

FIG. 15 is a front view showing the structure of a defect inspection apparatus 100c according to the fourth embodiment of the present invention.

Referring to FIG. 15, in the defect inspection apparatus 100c of the present embodiment, frame 20 includes arms 22 and 23 not connected to each other and does not include main body part 21 and extending part 24 (FIG. 1). The light source 31, the line camera 32, and the lens 33 are fixed to the arm 22. The light source 41, the line camera 42, and the lens 43 are fixed to the arm 23.

The camera light source movement drive unit 52 also includes two camera light source movement drive units 52a and 52b. By applying power to the arm 22, as indicated by an arrow AR 21, the camera light source movement drive unit 52a moves the arm 22, the light source 31, the line camera 32, and the lens 33 along the central axis CX (in the vertical direction). By applying power to the arm 23, as indicated by an arrow AR 22, the camera light source movement drive unit 52b moves the arm 23, the light source 41, the line camera 42, and the lens 43 along the central axis CX (in the vertical direction).

That is, by moving each of the arm 22 and the arm 23 independently of each other, the camera light source movement drive unit 52 moves the light source 31, the line camera 32 and the lens 33, and the light source 41, the line camera 42 and the lens 43 independently of each other. Thereby, during rotation of the intermediate transfer belt 1, at a timing different from the timing at which the line camera 42 receives the light from a predetermined area on the inner surface 1b, the line camera 32 can receive light from the area corresponding to the predetermined area on the outer surface 1a.

Next, the operation of the defect inspection apparatus 100b in the present embodiment will be described.

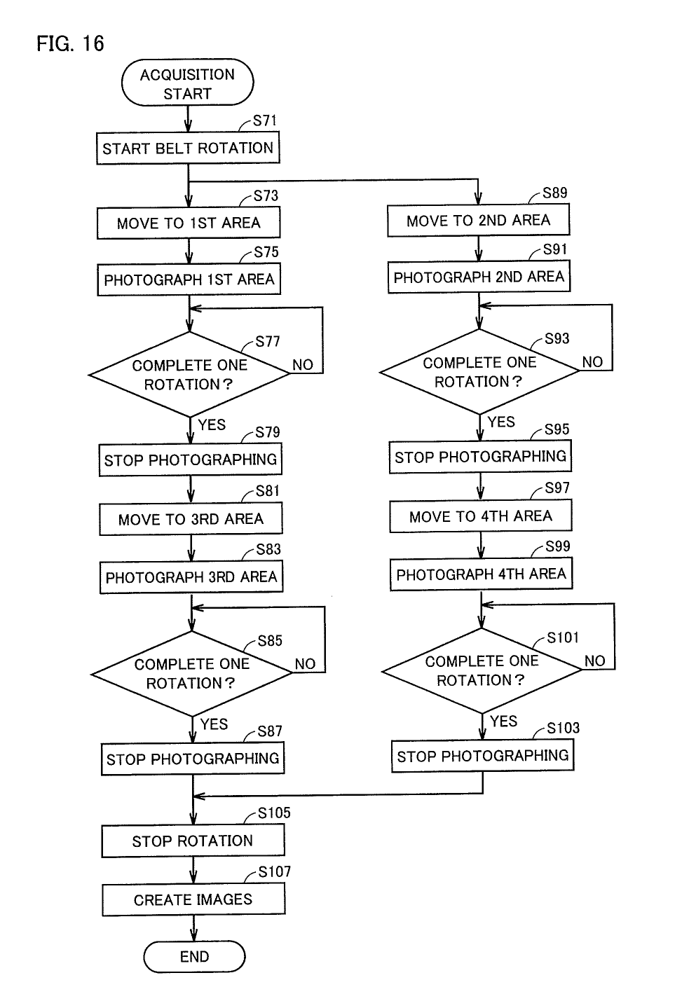

FIG. 16 is a flowchart showing the image acquisition operation of the defect inspection apparatus 100c according to the fourth embodiment of the present invention.

Referring to FIG. 16, the CPU starts the rotation of the intermediate transfer belt 1 (S71). The CPU moves the line camera 32 to the shooting position of the first area (one of the areas RG 1 and RG 3) (S73). The CPU starts photographing of the first area (S75). The CPU determines whether the intermediate transfer belt 1 makes one complete rotation from the start of photographing of the first area of the line camera 32 (S77). The CPU repeats the processing of step S77 until it is determined that the intermediate transfer belt 1 makes one rotation from the start of photographing of the first area of the line camera 32.

In step S77, when it is determined that the intermediate transfer belt 1 makes one rotation from the start of photographing of the first area of the line camera 32 (YES in S77), the CPU stops photographing by the line camera 32 (S79) and moves the line camera 32 to the shooting position of the third area (the other of the areas RG 1 and RG 3) (S81). The CPU starts photographing of the third area (S83) and determines whether the intermediate transfer belt 1 makes one complete rotation from the start of photographing of the third area of the line camera 32 (S85). The CPU repeats the process of step S85 until it is determined that the intermediate transfer belt 1 makes one rotation from the start of photographing of the third area of the line camera 32.

In step S85, when it is determined that the intermediate transfer belt 1 makes one complete rotation from the start of the imaging of the third area of the line camera 32 (YES in S 85), the CPU stops photographing by the line camera 32 (S87), and the process proceeds to step S105.

In parallel with the processes (steps S73 to S87) concerning photographing by the line camera 32, the CPU performs processing (steps S89 to S103) regarding the photographing by the line camera 42. Following the process of step S71, the CPU moves the line camera 42 to the shooting position of the second area (one of the areas RG 2 and RG 4) (S89). The CPU starts photographing in the second area (S91) and determines whether the intermediate transfer belt 1 makes one complete rotation from the start of photographing in the second area of the line camera 42 (S93). The CPU repeats the process of step S93 until it is determined that the intermediate transfer belt 1 makes one rotation from the start of photographing of the second area of the line camera 42.

In step S93, when it is determined that the intermediate transfer belt 1 makes one rotation from the start of photographing in the second area of the line camera 42 (YES in S93), the CPU stops photographing by the line camera 42 (S95) and moves the line camera 42 to the shooting position of the fourth area (the other of the areas RG 2 and RG 4) (S97). The CPU starts photographing of the fourth area (S99), and determines whether the intermediate transfer belt 1 makes one complete rotation from the start of the photographing of the fourth area of the line camera 42 (S101). The CPU repeats the processing of step S101 until it is determined that the intermediate transfer belt 1 makes one rotation from the start of photographing of the fourth area of the line camera.

In step S101, when it is determined that the intermediate transfer belt 1 makes one rotation from the start of photographing in the fourth area of the line camera 42 (YES in S101), the CPU stops photographing by the line camera 32 (S103), and the process proceeds to step S105.

In step S105, after the photographing of each of the line cameras 32 and 42 is stopped (at the timing when all photographing is completed), the CPU stops the rotation of the intermediate transfer belt 1 (S105), creates an outer surface image and an inner surface image (S107), and terminates the process.

The configuration and operation of the defect inspection apparatus 100c in the present embodiment is the same as the configuration and operation of the defect inspection apparatus 100 in the first embodiment. For this reason, the same members are denoted by the same reference numerals, and description thereof will not be repeated.

According to the present embodiment, the line camera 32 for photographing the outer surface 1a and the line camera 42 for photographing the inner surface 1b can be individually moved, and imaging by line camera 32 and imaging by line camera 42 can be performed at different timings. Further, the size of the imaging area of the line camera 32 and the size of the imaging area of the line camera 42 can be individually set. By way of example, by making the distance between the line camera 32 and the intermediate transfer belt 1 larger than the distance between the line camera 42 and the intermediate transfer belt 1, the imaging area of the line camera 32 can be made larger than the imaging area of the line camera 42.

### Others

Multiple line cameras may shoot using light from one light source.

The above-described embodiments can be combined with each other. For example, in the third embodiment, the bearing 12 and the rotating rail 13 are fixed to the frame 20. In the first embodiment, each of the outer surface 1a and the inner surface 1b is photographed by one of the line cameras 32 and 42, respectively. The configuration of the third embodiment may be applied to the configuration of the first embodiment. In the fourth embodiment, the line camera 32 for photographing the outer surface 1a and the line camera 42 for photographing the inner surface 1b are independently movable. In the second embodiment, each of the outer surface 1a and the inner surface 1b is photographed by the plurality of line cameras 32a and 32b and the line cameras 42a and 42b, respectively. The configuration of the fourth embodiment may be applied to the configuration of the second embodiment.

The processing in the above-described embodiment may be performed by software or may be performed using a hardware circuit. Further, it is also possible to provide a program for executing the processing in the above embodiment. The program may be recorded in a recoding medium such as a CD-ROM, a flexible disk, a hard disk, a ROM, a RAM, a memory card, etc., and provided to the user. The program is executed by a computer such as a CPU. Further, the program may be downloaded to the apparatus via a communication line such as the Internet.

Although the present invention has been described and illustrated in detail, the disclosed embodiments are made for purposes of illustrated and example only and not limitation. The scope of the present invention being interpreted by terms of the appended claims.

### Effect of Embodiment

According to the present embodiment, it is possible to provide a defect inspection apparatus capable of improving defect detection accuracy.

What is claimed is:

1. A defect inspection apparatus for a tubular product comprises
an external irradiation unit for irradiating an outer surface of the tubular product with light,
an external light receiver for receiving the light from the outer surface and transmitting a signal based on the received light,
an internal irradiation unit for irradiating an inner surface of the tubular product with light,
an internal light receiver for receiving the light from the inner surface and transmitting a signal based on the received light,
an image processing unit for creating an outer surface image which is a two-dimensional image of the outer surface, based on the signal received from the external light receiver, and creating an inner surface image which is a two-dimensional image of the inner surface, based on the signal received from the internal light receiver, and
a detection unit for detecting a defect included in the tubular product, based on the outer surface image and the inner surface image.

2. The defect inspection apparatus for a tubular product according to claim 1, wherein the detection unit includes
an outer surface detection unit for detecting a defect included in the outer surface, based on the outer surface image,
an inner surface detection unit for detecting a defect included in the inner surface, based on the inner surface image,
a determination unit for determining, when a defect was detected on one of the outer surface and the inner surface, whether or not a defect is detected on another surface of the outer surface and the inner surface, at a position corresponding to a position of the defect detected on the one surface, and
an identification unit for identifying, when it is determined by the determination unit that a defect is detected at the position on another surface, the defect detected on the one surface and the defect detected on the another surface as a same kind of defect of the first type, wherein
the detection unit does not identify the defect detected on the one surface as the first type of defect, when it is determined by the determination unit that a defect is not detected at the position on the other surface.

3. The defect inspection apparatus for a tubular product according to claim 2, wherein
the determination unit determines whether a defect is detected at the position on the outer surface corresponding to the position of the defect detected at the inner surface, when a defect is detected at the inner surface, and
the identification unit does not identify the defect detected at the inner surface as a defect, when it is determined by the determination unit that a defect is not detected at the position on the outer surface.

4. The defect inspection apparatus for a tubular product according to claim 3, wherein
the determination unit determines whether a defect is detected at the position on the inner surface corresponding to the position of the defect detected at the outer surface, when defect is detected at the outer surface, and
the identification unit identifies a defect detected at the outer surface as a second type of defect different from the first type, when it is determined by the determination unit that a defect is not detected at the position on the inner surface.

5. The defect inspection apparatus for a tubular product according to claim 1, further comprising
a rotating part for rotating the tubular product around a central axis, and
a movement drive unit for moving each of the external irradiation unit, the external light receiver, the internal irradiation unit, and the internal light receiver, along the central axis.

6. The defect inspection apparatus for a tubular product according to claim 5, wherein the image processing unit includes
a first image creation unit for creating the outer surface image and the inner surface image of the first portion of the tubular product, by rotating the tubular product one turn by the rotating part, in a state where each of the external irradiation unit, the external light receiver, the internal irradiation unit, and the internal light receiver has been moved to the first position by the movement drive unit, and
a second image creation unit for creating the outer surface image and the inner surface image of a second portion different from the first portion in the tubular product by rotating the tubular product one turn by the rotating part, in a state where each of the external irradiation unit, the external light receiver, the internal irradiation unit, and the internal light receiver has been moved to the first position by the movement drive unit has been moved to the second position different from the first position by the movement drive unit.

7. The defect inspection apparatus for a tubular product according to claim 5, wherein the rotating part includes
a first holding unit for holding one end portion of the tubular product in a state where the central axis is in a vertical direction,
a second holding unit for holding another end portion of the tubular product in a state where the central axis is in a vertical direction, and
a rotary drive unit for rotating the first and second holding units, wherein
a holding unit of at least one of the first and second holding units is annular, and
the movement drive unit moves each of the internal irradiation unit and the internal light receiver into and out of an interior of the tubular product through the at least one of the holding units.

8. The defect inspection apparatus for a tubular product according to claim 5, further comprising
a frame that fixes each of the external irradiation unit, the external light receiver, the internal irradiation unit, and the internal light receiver, wherein
the movement drive unit moves each of the external irradiation unit, the external light receiver, the internal irradiation unit, and the internal light receiver, by moving the frame along the central axis.

9. The defect inspection apparatus for a tubular product according to claim 5, wherein
the frame includes a first frame for fixing each of the external irradiation unit and the external light receiver, and a second frame for fixing each of the internal irradiation unit and the internal light receiver, and
the movement drive unit moves the external irradiation unit and the external light receiver, the internal irradiation unit, and the internal light receiver independently of each other, by moving each of the first frame and the second frame independently of each other.

10. The defect inspection apparatus for a tubular product according to claim 5, further comprising
a frame that fixes each of the external irradiation unit, the external light receiver, the internal irradiation unit, and the internal light receiver, wherein
the rotating part includes
a first holding unit for holding one end portion of the tubular product in a state where the central axis is in a vertical direction,
a second holding unit for holding another end portion of the tubular product in a state where the central axis is in a vertical direction, and
a rotary drive unit for rotating the first and second holding units, wherein
the frame further fixes the first holding unit, and
the movement drive unit moves each of the external irradiation unit, the external light receiver, the internal irradiation unit, and the internal light receiver, and the first holding unit, by moving the frame along the central axis.

11. The defect inspection apparatus for a tubular product according to claim 5, wherein
the external light receiver has a plurality of receivers, and each of the plurality of external light receivers is arranged along the central axis, and
the internal light receiver has a plurality of receivers, and each of the plurality of internal light receivers is arranged along the central axis.

12. The defect inspection apparatus for a tubular product according to claim 5, wherein
the internal light receiver receives light from an area corresponding to the predetermined area in the inner surface, during rotation of the tubular product, at the same timing as the external light receiver receives light from a predetermined area on the outer surface.

13. The defect inspection apparatus for a tubular product according to claim 5, wherein
the external light receiver receives light from an area corresponding to the predetermined area on the outer surface, during rotation of the tubular product, at a timing different from the timing at which the internal light receiver receives light from a predetermined area on the inner surface.
